(19) United States
(12) Patent Application Publication
(10) Pub. No.: US 2024/0110584 A1
(43) Pub. Date: Apr. 4, 2024

(54) Shmitchik

(71) Applicant: Moshe Finkelstein, Brooklyn, NY (US)

(72) Inventor: Moshe Finkelstein, Brooklyn, NY (US)

(21) Appl. No.: 17/959,514

(22) Filed: Oct. 4, 2022

(51) Int. Cl. F16B 2/22; F16M 13/02

(52) U.S. Cl. CPC F16B 2/22; F16M 13/022

(57) ABSTRACT

A mounting clip assembly for mounting to an object is disclosed. The mounting clip assembly includes an elongated section, curved sections, and first tabs. The elongated section includes arms extending from distal ends of the elongated section. The arms position at an inclined angle corresponding to the elongated section. The curved section extends from said first arm and each of said curved sections positions in a convex configuration. The first tabs extend outwardly from the distal end of the curved section. The curved sections receive an object of varied shape and size, and the first tabs allow said curved sections to connect to the object without damaging the object. The mounting clip assembly is self-adjusting, easy to mount and unmount.

### FIELD OF THE INVENTION

The present invention relates to mounting clips or accessories used to connect or suspend objects, and more specifically, the present invention relates to a mounting clip assembly or bracket configured to connect to objects such as a shelf, pipe, frame or any other mounting surface.

### BACKGROUND OF THE INVENTION

Typically, clips or brackets are used to connect or hold objects in a particular position or to connect to other structures. Optionally, the clips or brackets having fasteners are used to connect to the objects. The objects include, but limited to, shelfs, pipes, frames or other mounting surfaces. As known, the fasteners come in different lengths and have a variety of threading. As a result, it is difficult to select the fasteners having appropriate length and threading to penetrate the fasteners into the objects/brackets to connect the brackets to the objects. Optionally, the brackets connect to the objects using adhesives or welding. Use of the fasteners or welding to connect the clips to the objects disrupt and/or weaken the connection between the clips and the surface of the objects.

Several mounting clips have been disclosed in the past to connect the clips and the objects. One such example is disclosed in a granted U.S. Pat. No. 6,364,263, entitled, “Fixture support system” (“the '263 Patent”). The '263 Patent discloses a shelving system having an appearance of a suspended shelf including a panel, a pair of narrow profile shelf clips and a cantilevered shelf secured in the shelf clips. The panel includes a vertical series of holes formed into each side. Each shelf clip has an upper and lower pin to engage holes in the side edge of the back panel. Each clip includes an upper shelf brace and a lower shelf brace defining a shelf space there between for the seating of a shelf. The upper and lower shelf braces each include a friction pad to snugly engage the upper and lower surfaces of a margin of the shelf. The friction pads are interchangeable to provide a plurality of thicknesses to adjust the dimension of the shelf space so as to accommodate shelves of varying thicknesses. In other embodiments, the shelf clips can be fashioned as display hardware including straight faceout with hooks, a round faceout, a straight shelf bracket, a hat displayer, a hang rail support bracket, a valance bracket, a hang rail support bracket or alternative configurations.

Another example is disclosed in a granted U.S. Pat. No. 9,945,403, entitled “Rigid foam board installation clip” (“the '403 Patent”). The '403 Patent discloses a clip for facilitating installation of foam insulation boards in a building structure. The clip comprises a body, a spacer and a foot for holding the insulation board, and a connection region for attachment of the clip to a building structural member. The clip is designed to ensure proper ventilation and greatly easy the proper installation of rigid foam insulation. The clip can be attached to the building structural members (rafters, joists, beams, etc.) in any manner capable of supporting the insulation. For example, the clip can be mechanically connected to the structural members by fasteners such as nails, staples, screws, tacks, and the like. In other embodiments, adhesives, pressure connections, and the like can be employed.

Yet another example is disclosed in a granted U.S. Pat. No. 9,068,358, entitled “Wall panel systems for rigid wall panels” (“the '358 Patent”). The '358 Patent discloses wall panel systems. The systems use interlocking brackets to attach photovoltaic (PV), ceramic, or other rigid wall panels to an exterior wall of a building. The interlocking components include a plurality of wall mounting brackets configured to carry the dead loads of the respective wall panels, and a plurality of panel brackets that may be quickly hung from the wall mounting brackets. The wall mounting brackets are configured to be operatively fastened to an exterior wall surface, while each of the panel brackets is adhesively attached to the rear surface of a respective panel. Each of the wall mounting brackets and the nested panel brackets is substantially similar in dimension and configuration. Further, the system is configured to allow wall panels to be attached to the bracket assemblies in any sequence.

Although the above-discussed mounting clips are useful to connect the clips and the objects, they have a few problems. For instance, the above-discussed mounting clips are limited in their functionality in that they can be used with the help of fasteners. As presented above, the fasteners disrupt and/or weaken the connection between the clips and the objects. Further, the fasteners affect the aesthetic appeal of the objects. Furthermore, the fasteners require additional tools to remove the connection between the clips and the objects. As a result, it becomes difficult to reposition the objects from one place to another.

Therefore, there is a need for an improved mounting clip assembly that is easy to use, self-adjusts, and allows for quick assembly and disassembly from any objects.

### SUMMARY

It is an object of the present invention to provide a mounting clip assembly that avoids the drawbacks of known mounting clips.

It is another object of the present invention to provide a mounting clip assembly that is capable of self-adjusting to snugly fit onto objects of various sizes and shapes.

It is another object of the present invention to provide a mounting clip assembly that prevents the use of the expensive welding machines as in the conventional mounting clips or systems.

It is yet another object of the present invention to provide a mounting clip assembly that prevents the use of fasteners such as screws.

It is yet another object of the present invention to provide a mounting clip assembly that prevents the damage to the objects when the mounting clip assembly is connected or removed.

In order to achieve one or more objects, the present invention discloses a mounting clip assembly. The mounting clip assembly includes an elongated section, arms, curved sections, and first tabs. The arms extend from distal ends of the elongated section. The arms position at an inclined angle corresponding to the elongated section. The curved sections extend from the arms. Each of the curved sections positions in a convex configuration. The first tabs extend outwardly from distal ends of respective curved sections. The curved sections receive an object of varied shape and size. The object includes, but not limited to, a pole, a frame, a door, a shelf, etc.

Further, the elongated section includes a hook receiving member. The hook receiving member extends from the elongated section at the opposite side of the arms and connects to the elongated section via a neck.

The mounting clip assembly further includes a lever having a frame. The frame comes in a C-shaped configuration. In other words, the frame indicates a claw-like structure or clamp-like structure. The frame includes a handle, a second tab, and connecting tabs. The connecting tabs position or fit over the hook receiving member. The second tab extends outwardly from a connecting tab of the connecting tabs. The handle helps to turn the frame and in turn the hook receiving member to tighten or lock the mounting clip assembly to the object. Once locked, the lever is removed from the hook receiving member, while retaining the hook receiving member connecting to the object. In order to remove the lever/frame, the second tab is engaged to remove the vacuum connection between the frame and the hook receiving member.

Furthermore, the curved sections include grip members. The grip members come in contact with the object and prevent damage to the object. Further, the grip members reduce the wear and tear on the curved members.

In one advantageous feature of the present invention, the curved sections extend and receive the object of various shapes and/or sizes. Further, the first tabs extend outward thereby allowing the curved sections to connect to the object of any shape and/or size without damaging the object.

In another advantageous feature of the present invention, the grip members are flexible and self-adjusts corresponding to the shape of the object. As a result, the grip members receive the object of any shape or size at the curved sections. Further, the mounting clip assembly helps to hold the object firmly.

In another advantageous feature of the present invention, the mounting clip assembly is simple in construction and avoids the use of fasteners and/or welding. As a result, the mounting clip assembly is easy to mount and unmount. Further, the mounting clip assembly is easily removed and repositioned from one location to another.

In yet another advantageous feature of the present invention, the lever helps to mount the clip to the object and remove the frame from the clip easily.

In yet another advantageous feature of the present invention, the mounting clip assembly acts as a hanging feature along rails and other tube structures of various sizes and cross sections.

Features and advantages of the invention hereof will become more apparent in light of the following detailed description of selected embodiments, as illustrated in the accompanying FIGUREs. As will be realised, the invention disclosed is capable of modifications in various respects, all without departing from the scope of the invention. Accordingly, the drawings and the description are to be regarded as illustrative in nature.

### BRIEF DESCRIPTION OF THE DRAWINGS

The present invention will now be described in detail with reference to the drawings, which are provided as illustrative examples of the invention so as to enable those skilled in the art to practice the invention. It will be noted that throughout the appended drawings, like features are identified by like reference numerals. Notably, the FIGUREs and examples are not meant to limit the scope of the present invention to a single embodiment, but other embodiments are possible by way of interchange of some or all of the described or illustrated elements and, further, wherein:

FIG. 1 shows an environment in which a mounting clip assembly implements, in accordance with one embodiment of the present invention;

FIG. 2 shows another environment in which a mounting clip assembly implements, in accordance with one embodiment of the present invention;

FIGS. 3 and 6 show a perspective view, and a top view, respectively of a clip having grip members, in accordance with one embodiment of the present invention;

FIGS. 4A and 4B show a perspective view and a top view, respectively, of the clip, in accordance with one embodiment of the present invention;

FIG. 5 shows a perspective view of the grip members, in accordance with one embodiment of the present invention;

FIGS. 7A and 7B show a perspective view and a side view, respectively, of a lever, in accordance with one embodiment of the present invention;

FIG. 8 shows the lever aligned with the clip, in accordance with one embodiment of the present invention;

FIGS. 9A, 9B and 9C show a perspective view, a top view, and a side view, respectively, of the lever connected to the clip, in accordance with one embodiment of the present invention; and

FIG. 10 shows removal of the lever from the clip, in accordance with one embodiment of the present invention.

### DETAILED DESCRIPTION OF THE EMBODIMENTS

Before the present features and working principle of a mounting clip assembly is described, it is to be understood that this invention is not limited to the particular device as described, since it may vary within the specification indicated. Various features of a mounting clip assembly might be provided by introducing variations within the components/subcomponents disclosed herein. It is also to be understood that the terminology used in the description is for the purpose of describing the particular versions or embodiments only, and is not intended to limit the scope of the present invention. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items.

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure.

In the present specification, an embodiment showing a singular component should not be considered limiting. Rather, the invention preferably encompasses other embodiments including a plurality of the same component, and vice-versa, unless explicitly stated otherwise herein. Moreover, the applicant does not intend for any term in the specification to be ascribed an uncommon or special meaning unless explicitly set forth as such. Further, the present invention encompasses present and future known equivalents to the known components referred to herein by way of illustration.

Although the present disclosure provides a description of a mounting clip assembly, it is to be further understood that numerous changes may arise in the details of the embodiments of the mounting clip assembly. It is contemplated that all such changes and additional embodiments are within the spirit and true scope of this disclosure.

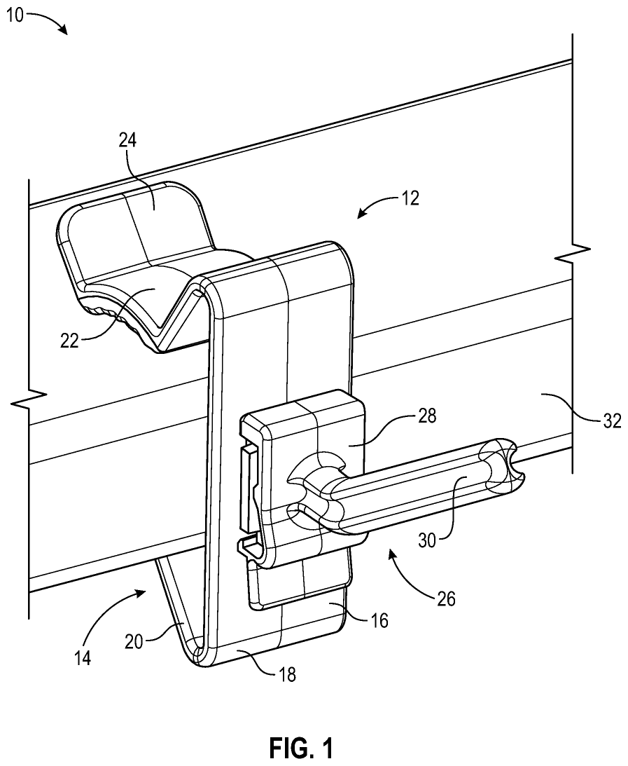

Various features and embodiments of a mounting clip assembly are explained in conjunction with the description of FIGS. 1-10.

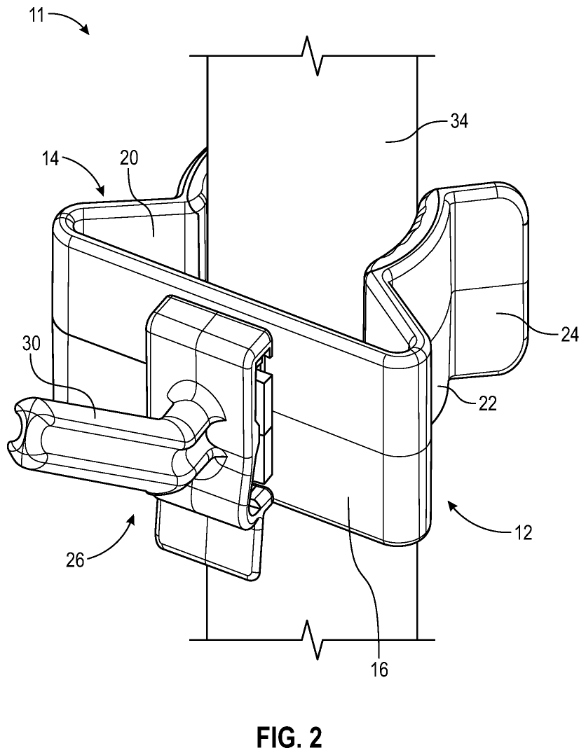

FIG. 1 shows an environment 10 in which a mounting clip assembly 12 implements, in accordance with one embodiment of the present invention. Mounting clip assembly 12 mounts on to an object 32. In one example, object 32 includes, but not limited to, a door, a shelf, a frame, a pole etc., having a rectangular configuration. FIG. 2 shows another environment 11 in which mounting clip assembly 12 implements, in accordance with one embodiment of the present invention. Here, environment 11 is shown to illustrate mounting clip assembly 12 connecting to another object 34 having a different shape. In one example, object 34 includes a pole having a cylindrical configuration. It should be understood that objects 32, 34 can come in any other configuration without departing from the scope of the present invention. As such, the presently disclosed mounting clip assembly 12 can be used to connect to objects 32, 34.

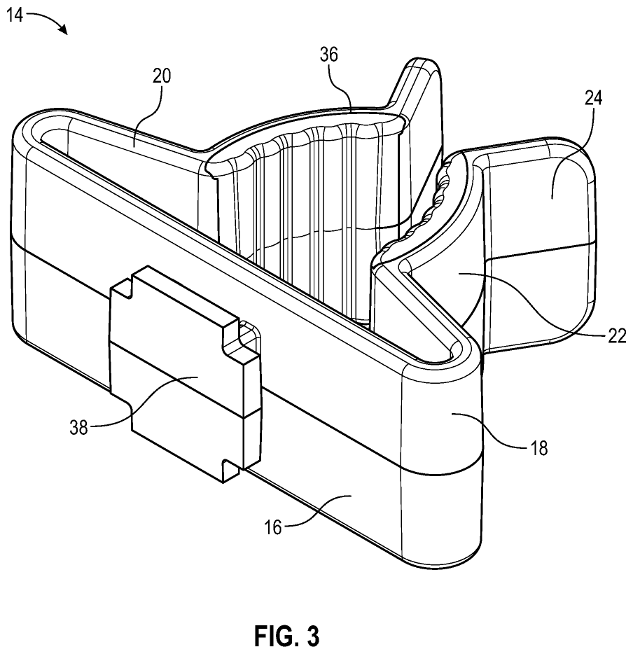

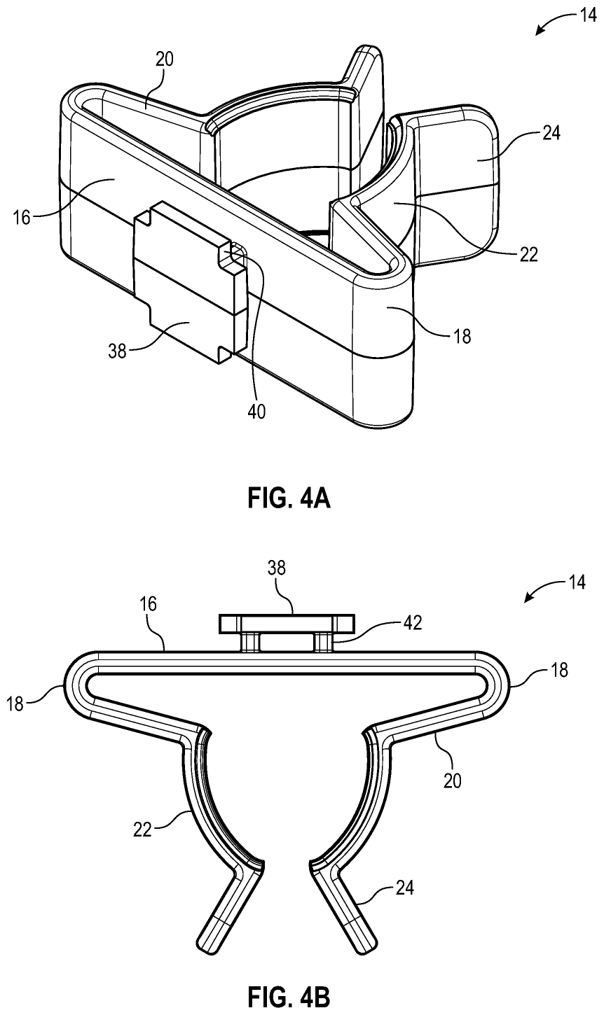

Mounting clip assembly 12 includes a clip 14 and a lever or hook 26. FIG. 3 shows a perspective view of clip 14, in accordance with one embodiment of the present invention. Further, FIGS. 4A and 4B show a perspective view and a top view, respectively, of clip 14, in accordance with one embodiment of the present invention. Clip 14 is made of a metal, plastic, wood, or any other suitable material. Clip 14 includes an elongated section 16. Elongated section 16 comes in a substantial flat rectangular or square configuration depending on the need. Clip 14 includes end sections 18. End sections 18 position at distal ends of elongated section 16. End sections 18 come in a curved configuration or a semi-circular configuration. Clip 14 includes arms 20. Arms 20 extend from end sections 18. Arms 20 position at an inclined angle corresponding to elongated section 16. Further, clip 14 includes curved sections 22, as shown in FIGS. 4A and 4B. Curved sections 22 extend from arms 20. Each curved section 22 positions in a convex configuration. Furthermore, clip 14 includes first tabs 24. First tabs 24 extend outwardly from the distal end of curved sections 22, as shown in at least FIG. 4B.

Further, elongated section 16 includes a hook receiving member 38. Hook receiving member 38 extends from elongated section 16 at the opposite side of arms 20, as shown in at least FIG. 4B. Hook receiving member 38 comes in a variety of shapes and sizes depending on need. In one example, hook receiving member 38 comes in a square configuration. In one implementation, hook receiving member 38 includes cut-out sections 40. Cut-out sections 40 come in an L-shaped or step-like configuration and form at each corner of hook receiving member 38. Hook receiving member 38 connects to elongated section 16 via a neck 42, as shown in at least FIG. 4B. Neck 42 acts as an intermediate portion between elongated section 16 and hook receiving member 38. Neck 42 comes in a rectangular square circle or other suitable configuration.

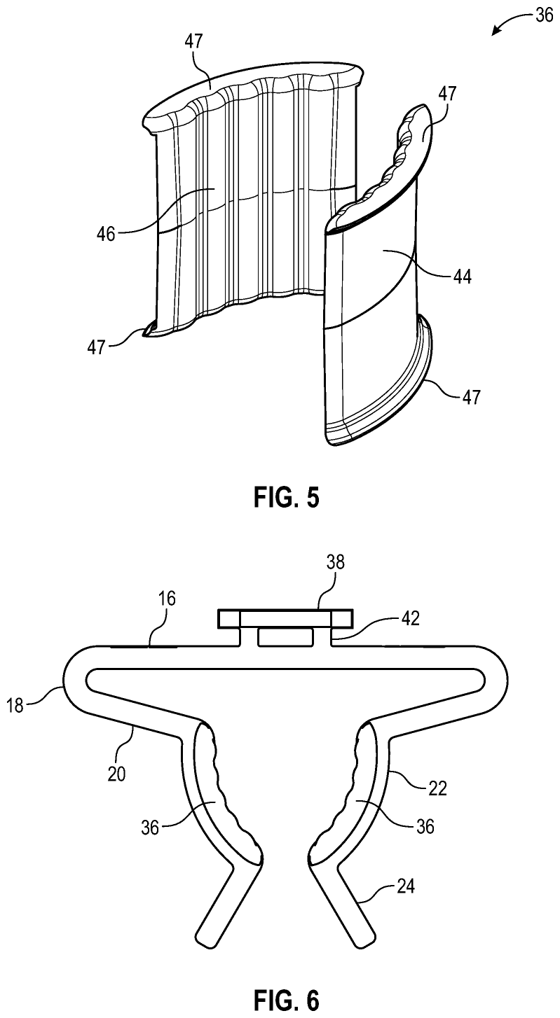

In one implementation, curved sections 22 receive grip members 36. FIG. 5 shows a perspective view of grip members 36 facing each other, in accordance with one embodiment of the present invention. Grip member 36 is made of a suitable material such as rubber, polymers, elastomers, or any suitable flexible material. Each grip member 36 includes a first side 44 and a second side 45. First side 44 indicates a front portion and second side indicates a rear portion of grip member 36. First side 44 includes a smooth surface that attaches to curved sections 22 via connecting means (not shown). Connecting means include all means known in the art including, but not limited to, adhesive, double-sided tape, and fastener, etc. Second side 45 includes a plurality of ribs 46 positioned in a vertical manner. Ribs 46 protrude from the surface of second side 45 and provide friction to hold objects 32, 34. Further, grip members 36 includes lips 47. Lips 47 extend outwardly from the first side 45 at the top and bottom. Lips 47 go over curved section 22 and connect to curved sections 22. FIG. 6 shows a top view of clip 14 having grip members 36 connected at curved sections 22, in accordance with one embodiment of the present invention.

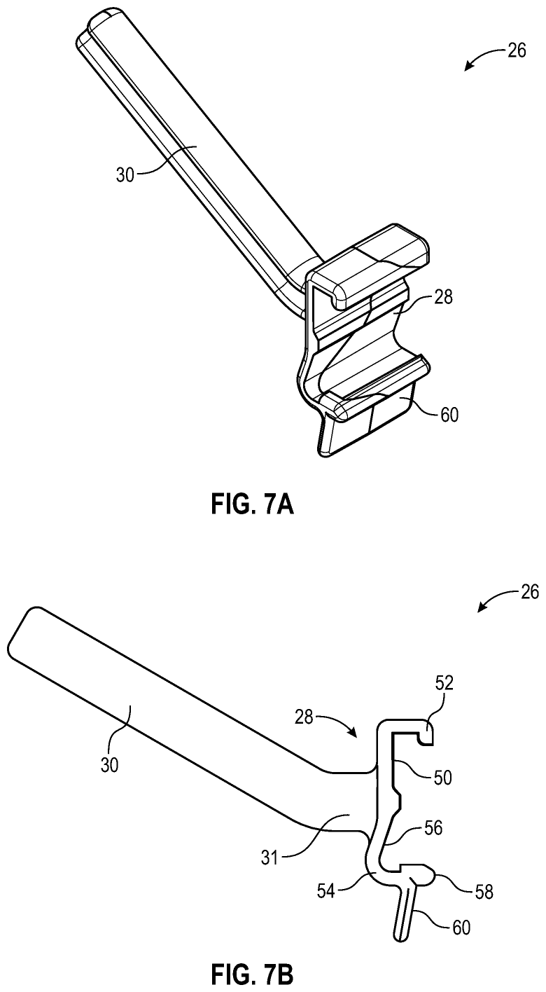

FIGS. 7A and 7B show a perspective view and a side view, respectively, of a lever 26, in accordance with one embodiment of the present invention. Lever 26 comes in a rigid or flexible material depending on the need. It is preferable to provide lever 26 in a flexible material. Lever 26 includes a frame 28. Frame 28 comes in a substantially C-shaped configuration or claw-like structure or clam-like structure. Here, frame 28 acts as a clamp or clasp to connect lever 26 to hook receiving member 38. Frame 28 includes a handle 30. Handle 30 extends from frame 28. Handle 30 includes an angled portion 31. Angled portion 31 facilitates handle 30 to bend or rotate. In other words, handle 30 attaches to the rear portion of frame 28 via angled portion 31.

Further, frame 28 includes a first extending section 50. First extending section 50 encompasses a first connecting tab 52. First connecting tab 52 extends substantially perpendicularly from first extending section 50 and forms a hook-like structure with first extending section 50. Further, frame 28 includes a second extending section 54. Second extending section 54 extends in the opposite direction of first extending section 50. Second extending section 54 encompasses a tapered section 56. Further, second extending section 54 includes a second connecting tab 58. Second connecting tab 58 extends substantially perpendicularly from second extending section 54 and forms a hook-like structure with second extending section 54. First extending section 50, first connecting tab 52, second extending section 54 and second connecting tab 58 form a substantially c-shaped frame 28.

Frame 28 includes a second tab 60. Second tab 60 extends outwardly from frame 28 i.e., from second connecting tab 58 at the bottom, as shown in at least FIG. 7B. Second tab 60 helps to remove or release vacuum or pressure created when frame 28 is connected to hook receiving member 38 such that frame 28 is disconnected from hook receiving member 38.

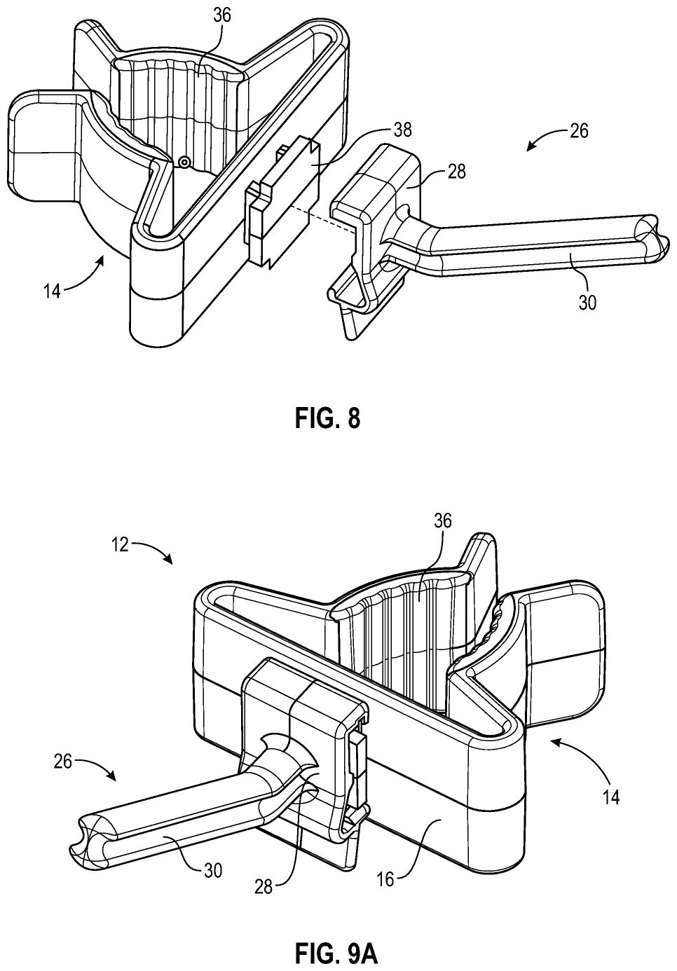

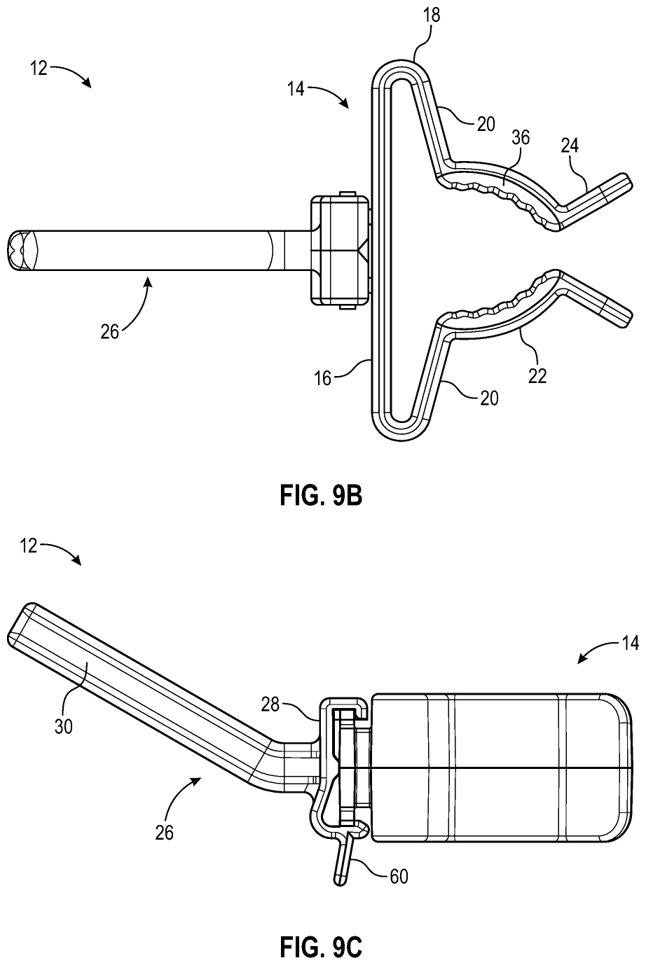

FIG. 8 shows lever 26 aligned with clip 14, in accordance with one embodiment of the present invention. Here, frame 28 aligns with hook receiving member 38. FIGS. 9A, 9B and 9C show a perspective view, a top view, and a side view, respectively, of lever 26 connected to clip 14, in accordance with one embodiment of the present invention. In order to connect lever 26 to clip 14, connecting tabs 52, 58 go over and lock to hook receiving member 38. In other words, connecting tabs 52, 58 firmly sit over the edges of hook receiving member 38, as shown in FIG. 9C. Connecting tabs 52, 58 ensure lever 26 does not slip off from clip 14. Here, connecting tabs 52, 58 allow lever 26 to act as a clip-on and clip-off thereby avoiding the interlock mechanism on all corners of hook receiving member 38. Further, when frame 28 connects to hook receiving member 38, tapered section 56 at second extending section 54 creates a vacuum gap between the surface of hook receiving member 38 and second extending section 54.

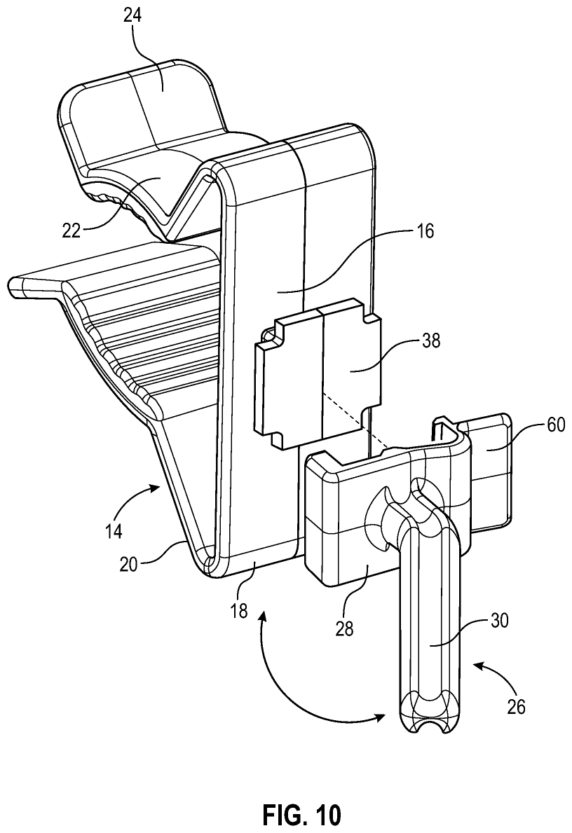

In one implementation, handle 30 turns or rotates to tighten or lock hook receiving member 38 such that object 32, 34 is held firmly between curved sections 22. Optionally, lever 26 is removed and turned 90 degrees to align lever 26 with a horizontal or vertical hook receiving member 38 (FIG. 10).

In use, curved sections 22 receive objects 32, 34. Distal ends of curved sections 22 positions over object 32 (rectangular object) and stabilizes clip 26. Consider object 32 is in rectangular configuration. Here, curved sections 22 receive and position over the rectangular surface of object 32 and first tabs 24 rest over the rectangular surface of object 32, as shown in FIG. 1, for example. As curved sections 22 are provided in convex configuration, curved sections 22 help to hold object 34 (cylindrical object). This way, object 32, 34 of any shape can be received at curved sections 22. Grip members 36 help to resist the rotation of object 32, 34 within curved sections 22 or help to resist the rotation of mounting clip assembly 12 once installed. Further, grip members 36 allow mounting clip assembly 12 from falling off object 32, 34. A user holds handle 30 and connects frame 28 to hook receiving member 38. Further, the user pushes hook receiving member 38 such that curved sections 22 receive object 32, 34 via first tabs 24. As first tabs 24 position outwardly, object 32, 34 slips or slides through and goes into curved sections 22 without damaging object 32, 34. Grip members 36 come in contact with object 32, 34 and prevent damage to object 32, 34.

In order to remove lever 26 from hook receiving member 38, the user lifts/removes second tab 60. Lifting second tab 60 releases vacuum/locking pressure/vacuum gap created between the surface of hook receiving member 38 and second extending section 54. As the user lifts second tab 60, frame 28 disengages and allows second connecting tab 58 to come off hook receiving member 38. Subsequently, the user slides or lifts frame 28 entirely to remove lever 26 from hook receiving member 38, as shown in FIG. 10.

Based on the above, it is evident that the presently disclosed mounting clip assembly mounts onto an object without damage to the surface of the object or leaving sticky residue on the object. Further, the mounting clip assembly allows the objects to be either hanged, suspended, or attached from, or to, any square or tubular shaped objects. Furthermore, the mounting clip assembly is simple in construction that allows quick assembly and disassembly i.e., easily removable from the objects. Furthermore, the mounting clip assembly is a self-adjusting assembly to fit snugly on various sizes and shapes of shelves or rods.

A person skilled in the art appreciates that the mounting clip assembly may come in a variety of sizes depending on the need and comfort of the user. Further, different materials in addition to or instead of materials described herein may also be used and such implementations may be construed to be within the scope of the present invention. Further, many changes in the design and placement of components may take place without deviating from the scope of the presently disclosed assembly.

The clip and lever shown can be manufactured from a variety of material types. However, in preferred configurations, the clip and lever are manufactured using injection molding with flexible materials, including, but not limited to, HP Nylon 12, Nylon 6/6, elastomeric, thermoplastic, and metallic materials. Such materials should be substantially weather resistant such that they are not subject to significant corrosion upon frequent exposure to rain, snow, ice, humidity, etc. Alternatively, the materials may be impregnated with or coated with protective materials, such as but not limited to, antimicrobials, UV-resistant and/or flame retardants, which provide sufficient weather resistance.

For example, the mounting clip assembly is manufactured using injection molding. The mounting clip assembly is made of Nylon 6/6. In addition, the mounting part has ultimate tensile strength 60 Mpa (Mega Pascal), young modulus ranges from 1.8-1.9 GPa (Giga Pascal), and elongation (at break) ranges 15% to 20%.

The clip and lever may also be manufactured with different types of colors such that they blend with the objects. Alternatively, clip and lever may be manufactured having a contrasting color, decoration, or pattern that lends to building aesthetics or seasonal decor. In addition, clip and lever may have shapes and colors that are complementary to other decor positioned close to the objects.

In the above description, numerous specific details are set forth such as examples of some embodiments, specific components, devices, methods, in order to provide a thorough understanding of embodiments of the present invention. It will be apparent to a person of ordinary skill in the art that these specific details need not be employed, and should not be construed to limit the scope of the invention.

In the development of any actual implementation, numerous implementation-specific decisions must be made to achieve the developer's specific goals, such as compliance with system-related and business-related constraints. Such a development effort might be complex and time-consuming, but may nevertheless be a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

The foregoing description of embodiments is provided to enable any person skilled in the art to make and use the invention. Various modifications to these embodiments will be readily apparent to those skilled in the art, and the novel principles and invention disclosed herein may be applied to other embodiments without the use of the innovative faculty. It is contemplated that additional embodiments are within the spirit and true scope of the disclosed invention.

What is claimed is:

1. A mounting clip assembly, comprising:
an elongated section;
arms extending from distal ends of said elongated section, wherein said arms position at an inclined angle corresponding to said elongated section;
curved sections, each curved section extending from said first arm, and wherein each of said curved sections positions in a convex configuration; and
first tabs, each of first tab extending from outwardly from distal end of said curved section,
wherein said curved sections receive an object of varied shape and size, and wherein said first tabs allow said curved sections to connect to said object without damaging said object.

2. The mounting clip assembly of claim 1, wherein said curved sections comprise grip members, and wherein said grip members come in contact with said object and prevent damage to said object.

3. The mounting clip assembly of claim 1, wherein distal ends of said elongated section is curved.

4. The mounting clip assembly of claim 1, wherein said elongated section comprises a hook receiving member, and wherein said hook receiving member extends from said elongated section at the opposite side of said arms.

5. The mounting clip assembly of claim 4, wherein said hook receiving member connects to said elongated section via a neck.

6. The mounting clip assembly of claim 1, further comprises a frame, wherein said frame connects to said hook receiving member.

7. The mounting clip assembly of claim 6, wherein said frame comprises a second tab, wherein said second tab extends outwardly from said frame, and wherein said second tab helps to remove said frame from said hook receiving member.

8. The mounting clip assembly of claim 7, wherein said frame comprises a handle, wherein said handle helps to turn said frame to tighten or lock said mounting clip assembly to said object, and wherein said handle turns to remove said frame from said hook receiving member.

9. The mounting clip assembly of claim 7, wherein said frame comprises connecting tabs at distal ends, and wherein said second tab extends outwardly from a connecting tab of said connecting tabs and allow said frame to connect to said hook receiving member.

10. A mounting clip assembly, comprising:
an elongated section;
arms extending from distal ends of said elongated section, wherein said arms position at an inclined angle corresponding to said elongated section;
curved sections, each curved section extending from said first arm, and wherein each of said curved sections positions in a convex configuration;
first tabs, each of first tab extending from outwardly from distal end of said curved section;
a hook receiving member, wherein said hook receiving member extends from said elongated section at the opposite side of said arms;
a frame connecting said hook receiving member; and
a handle,
wherein said curved sections receive an object of varied shape and size, wherein said first tabs allow said curved sections to connect to said object without damaging said object; and wherein said handle helps to connect said frame to said elongated section.

11. The mounting clip assembly of claim 10, wherein said curved sections comprise grip members, and wherein said grip members come in contact with said object and prevent damage to said object.

12. The mounting clip assembly of claim 10, wherein said hook receiving member connects to said elongated section via a neck.

13. The mounting clip assembly of claim 10, wherein said frame comprises a second tab, wherein said second tab extends outwardly from said frame, and wherein said second tab helps to remove frame from said hook receiving member.

14. The mounting clip assembly of claim 10, wherein said frame comprises connecting tabs at distal ends, and wherein said connecting tabs allow said frame to connect to said hook receiving member.

15. A method of providing a mounting clip assembly, said method comprising the steps of:
providing an elongated section;
providing arms extending from distal ends of said elongated section, said arms positioning at an inclined angle corresponding to said elongated section;
providing curved sections, each curved section extending from said first arm, each of said curved sections positioning in a convex configuration;
providing first tabs, each of first tab extending from outwardly from distal end of said curved section; and
receiving an object of varied shape and size at said curved sections.

16. The method of claim 15, further comprising providing grip members at said curved sections, said grip members coming in contact with said object for preventing damage to said object.

17. The method of claim 15, further comprising providing a hook receiving member extending from said elongated section at the opposite side of said arms.

18. The method of claim 17, further comprising providing a frame connecting to said hook receiving member.

19. The method of claim 18, further comprising:
providing connecting tabs at distal ends of said frame, said connecting tabs allowing said frame to connect to said hook receiving member; and
providing a second tab at said frame, said second tab extending outwardly from a connecting tab of said connecting tabs for removing said frame from said hook receiving member.

20. The method of claim 19, further comprising providing a handle, said handle turning said frame to tighten or lock said mounting clip assembly to said object, said handle turning for removing said frame from said hook receiving member.
